(19) United States
(12) Patent Application Publication
(10) Pub. No.: US 2017/0152928 A1
(43) Pub. Date: Jun. 1, 2017

(54) 4-MODE POWERSPLIT TRANSMISSION BASED ON CONTINUOUSLY VARIABLE PLANETARY TECHNOLOGY

(71) Applicant: DANA LIMITED, Maumee, OH (US)

(72) Inventor: Matthias W. J. BYLTIAUW, Hooglede (BE)

(21) Appl. No.: 15/319,877

(22) PCT Filed: Jun. 26, 2015
(86) PCT No.: PCT/US2015/037916

§ 371 Date: Dec. 19, 2016

Related U.S. Application Data
(60) Provisional application No. 62/018,361, filed on Jun. 27, 2014.

(51) Int. Cl. F16H 37/08; F16H 3/66; F16H 15/28

(52) U.S. Cl. CPC F16H 37/086; F16H 15/28; F16H 3/666; F16H 2037/0886; F16H 2200/2005; F16H 2200/2041

(57) ABSTRACT

A variable transmission includes a powerpath layout based on multi-mode operation. The various modes are a combination of direct drive or power recirculation. An Infinitely Variable Planetary mode is present, allowing powered neutral feature. In all the modes, the Continuously Variable Planetary is speeded up with a single gear ratio, with the objective of reducing the Continuously Variable Planetary size by running it at high revolutions per minute. This configuration is based on a four mode solution, each mode being selected by closing a clutch/brake and releasing the others. A “common sun” compound planetary is the central part of the configuration together with the Continuously Variable Planetary. The configuration incorporates two forward modes consisting of a powersplit high-speed and direct drive mid-speed, a reverse direct drive mode and a powersplit infinitely variable planetary mode for low positive and reverse speeds as well as a powered neutral mode.

### CROSS-REFERENCE

This application claims the benefit of U.S. Provisional Application No. 62/018,361, filed Jun. 27, 2014, which application is incorporated herein by reference.

### BACKGROUND OF THE INVENTION

Automatic and manual transmissions are commonly used in the automotive market. Those transmissions become more and more complicated to improve fuel economy and minimize exhaust emissions. This finer control of the engine speed in conventional transmissions can typically be done by developing more advanced control algorithms or adding extra gears but with increased overall complexity and cost. In addition to these, Variable Transmissions have been proposed for Off-Highway (OH) applications such as compact wheel loaders.

### SUMMARY OF THE INVENTION

A variable transmission includes a powerpath layout based on multi-mode operation. The various modes are a combination of direct drive or power recirculation. An Infinite Variable Transmission (IVT) mode is present, allowing powered neutral feature. In all the modes, the Continuously Variable Planetary (CVP) device is speeded-up with a single gear ratio, with the objective of reducing the CVP size by running it at high revolutions per minute. This configuration is based on a four mode solution, each mode being selected by closing a clutch/brake and releasing the others. A “common sun” compound planetary is the central part of the configuration together with the CVP. The configuration incorporates two forward modes consisting of a powersplit high-speed and direct drive low-speed, a reverse direct drive mode and a powersplit infinitely variable planetary mode for low positive and reverse speeds as well as a powered neutral mode.

Provided herein is a variable transmission based on a four-mode solution comprising: an input shaft drivingly connected to a power source such as an internal combustion engine (ICE); a first gear ratio; a countershaft; a variator (CVP) comprising an input ring assembly drivingly engaged to the countershaft, and an output ring assembly; a compound planetary gearset comprising the elements; a common sun gear (S); a first set of planet gears; a first carrier (C1); a first ring gear (R1); a second set of planet gears; a second carrier (C2) and a second ring gear (R2); a first (F1) clutch; a second (F2) clutch; a second gear ratio; a third (R1) clutch; a fourth (IVP) clutch; a third (IVP) gear ratio; and an output shaft; wherein the countershaft is linked to the input shaft through the first gear ratio and the variator output ring assembly is linked to the common sun gear; and the second ring gear is the output of the compound planetary gearset and is drivingly engaged to the output shaft through a fourth gear ratio, alternately referred to as the speed ratio for axle reduction (SR_AR).

In some embodiments of the variable transmission, the first gear ratio is an up-speed ratio.

In some embodiments, the variable transmission further comprises an optional fifth gear ratio between the variator output ring assembly and the common sun gear.

In some embodiments of the variable transmission, the countershaft is coupled to the second carrier and first ring of the compound planetary gearset through the second gear ratio by engaging the second (F2) clutch, thus engaging a second forward mode.

In some embodiments of the variable transmission, the countershaft is coupled to the first carrier of the compound planetary gearset through the third (IVP) gear ratio by engaging the fourth (IVP) clutch, thus engaging an infinitely variable planetary (IVP) mode.

In some embodiments of the variable transmission, the first (F1) clutch is configured to lock any two elements of the compound planetary gearset to lock the compound planetary gearset in a 1:1 ratio and thus engaging a first forward mode. In any one of the embodiments of the variable transmission, any two elements of the compound planetary gearset are arbitrarily chosen.

In some embodiments of the variable transmission, the first (F1) clutch is located anywhere in the compound planetary gearset.

In other embodiments of the variable transmission, the first (F1) clutch is located between the common sun gear and the first carrier of the compound planetary gearset.

In some embodiments of the variable transmission, the third (R1) clutch is coupled between the first carrier of the compound planetary gearset and ground, and is closed to engage a reverse mode.

In some embodiments of the variable transmission, the second forward mode is a powersplit Over-Drive (OD) mode wherein power from the power source is split between the CVP and compound planetary gearset. In some embodiments, the second forward mode is configured to deliver high positive speeds.

In some embodiments of the variable transmission, the IVP mode is a powersplit mode wherein power from the power source (ICE) is split between the CVP and the compound planetary gearset. In some embodiments, the IVP mode is configured to deliver low positive and low reverse speeds.

In some embodiments of the variable transmission, the IVP mode is a powersplit mode wherein power from the power source (ICE) is split between the CVP and the compound planetary gearset and the transmission is configured to deliver a powered neutral mode.

In some embodiments of the variable transmission, the first forward mode is a direct-drive mode wherein all power from the power source (ICE) goes through the CVP. In some embodiments, the first forward mode is configured to deliver mid-speeds.

In some embodiments of the variable transmission, the reverse mode is a direct drive mode wherein all power from the power source goes through the CVP.

In some embodiments of the variable transmission, shifting between the IVP mode and the first forward mode and between the first forward mode and the second forward mode is synchronous. In some embodiments, shifting between the reverse mode and the IVP mode is non-synchronous.

In some embodiments of the variable transmission, the ratio between the power source (ICE) and the compound planetary gearset is the product of the first gear ratio and the second (F2) gear ratio.

In some embodiments of the variable transmission, the ratio between the power source (ICE) and the compound planetary gearset is the product of the first gear ratio, the variator ratio and a 1:1 ratio between the variator and the common sun. In other embodiments, the ratio between the power source (ICE) and the compound planetary gearset is the product of the first gear ratio, the variator ratio and the optional fifth gear ratio.

In some embodiments of the variable transmission, during normal operation within one mode, only one clutch is active or closed at one time. In other embodiments, during transitions between two modes, more than one clutch is partially closed at one time.

In any one of the embodiments of the variable transmission, the output shaft is connected to a differential and axle of a vehicle through the fourth gear ratio (SR_AR).

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator;

FIG. 2 is a magnified, side sectional view of a ball of a variator of FIG. 1 having a symmetric arrangement of a first ring assembly and a second ring assembly;

FIG. 3 is a block diagram of a typical continuously variable transmission (CVT) used in an Off-Highway (OH) vehicle;

FIG. 4 is an illustrative view of two forward modes of an exemplary multi-mode configuration transmission comprising a common sun compound planetary gear set, multiple clutches and gear ratios.

FIG. 5 is an illustrative view of an infinitely variable planetary mode of the exemplary multi-mode configuration transmission.

FIG. 6 is an illustrative view of a reverse mode of the exemplary multi-mode configuration transmission.

FIG. 7 is an illustrative view of the speed diagram of the compound planetary gear set illustrated in FIGS. 4-6.

FIG. 8 is an illustrative view of a physical layout of the exemplary multi-mode configuration transmission.

### DETAILED DESCRIPTION OF THE INVENTION

The continuously variable transmission speed ratio can have the advantage of providing a smoother and continuous transition from a low speed ratio to a high speed ratio. However, the prior continuously variable transmissions can be more complex than would be ideal.

Continuously Variable Transmissions or CVTs are of many types: belts with variable pulleys, toroidal, and conical, for non-limiting example. The principle of a CVT is that it enables the engine to run at its most efficient rotation speed by changing steplessly the transmission ratio in function of the speed of the car and the torque demand (throttle position) of the driver. If needed, for example when accelerating, the CVT is configured to also shift to the most optimum ratio providing more power. A CVT is configured to change the ratio from the minimum to the maximum ratio without any interruption of the power transmission, as opposed to the opposite of usual transmissions which require an interruption of the power transmission by disengaging to shift from one discrete ratio to engage the next ratio.

As used herein, a continuously variable transmission (CVT), (also known as single-speed transmission, gearless transmission, stepless transmission, variable pulley transmission, or in case of motorcycles, a twist-and-go) is an automatic transmission that can change seamlessly through an infinite number of effective gear ratios between maximum and minimum values, and are all used synonymously.

As used herein, Continuously Variable Planetary, Continuously Variable Planetary device, CVP and variator are all used synonymously. A continuously variable planetary (CVP) is based on a set of rotating, tilting balls each rotating on its own axle and resting about a central “sun”, fitted between two rings (input and output). Torque from an engine or other input power source is transferred to the input disc, then transmitted through the balls to the output disc using a thin layer of traction fluid. The speed of the output disc compared to the speed of the input disc, or speed ratio, is controlled by the angle of the ball axles relative to the axis of the transmission. Tilting the ball axles shifts the transmission from low to high or from high to low, or to any ratio in between. The number of balls used depends on several factors including torque and speed requirements, operational requirements and space considerations, among others.

As used herein, infinitely variable transmissions (IVT or IVTs), are a subset of CVT designs in which the range of ratios of output shaft speed to input shaft speed includes a zero ratio that can be continuously approached from a defined “higher” ratio. A zero output speed (low gear) with a finite input speed implies an infinite input-to-output speed ratio, which can be continuously approached from a given finite input value with an IVT. Low gears are a reference to low ratios of output speed to input speed. This low ratio is taken to the extreme with IVTs, resulting in a “neutral”, or non-driving “low” gear limit, in which the output speed is zero. Unlike neutral in a normal automotive transmission, IVT output rotation may be prevented because the backdriving (reverse IVT operation) ratio may be infinite, resulting in impossibly high backdriving torque; in a ratcheting IVT, however, the output may freely rotate in the forward direction.

As used herein Infinitely Variable Planetary, and IVP refer to a ball planetary variator (versus a belt-driven, toroidal or roller variator) that can move in forward or reverse and has a powered “zero state”. As with the IVT described above, the IVP provides a range of ratios of output shaft speed to input shaft speed and includes a zero ratio that can be continuously approached from a defined “higher” ratio. The IVP comprises a series of planet balls orbiting a central “sun”. The input is a first ring in contact with the orbiting planet balls and the output is a second ring in contact with the planet balls. As the planets tilt in one direction, the output speed slows. With the planet axles horizontal, “powered zero”, “powered neutral”, or “powered zero state” is achieved. As the planets continue to tilt in the opposite direction, the output changes from reverse to forward. A ball planetary variator can be configured as an Infinitely Variable Planetary (IVP) having a forward, reverse and powered zero state. In an IVP mode the first ring is constrained and not allowed to rotate. Power is input through the carrier holding the planets. Output is made through the second ring. At negative planet angles, the second ring spins slowly. As the planets rotate to a neutral angle or zero degrees, the second ring slows to a stop or “powered zero” state. As the plant angle increases from zero degrees to a positive angle, the second ring reverses course or produces a reverse mode.

Provided herein are configurations of CVTs based on a ball type variators, also known as CVP, for constant variable planetary. Some general aspects of the CVTs and CVPs are described in US20040616399 or AU2011224083A1, incorporated herein by reference in their entirety.

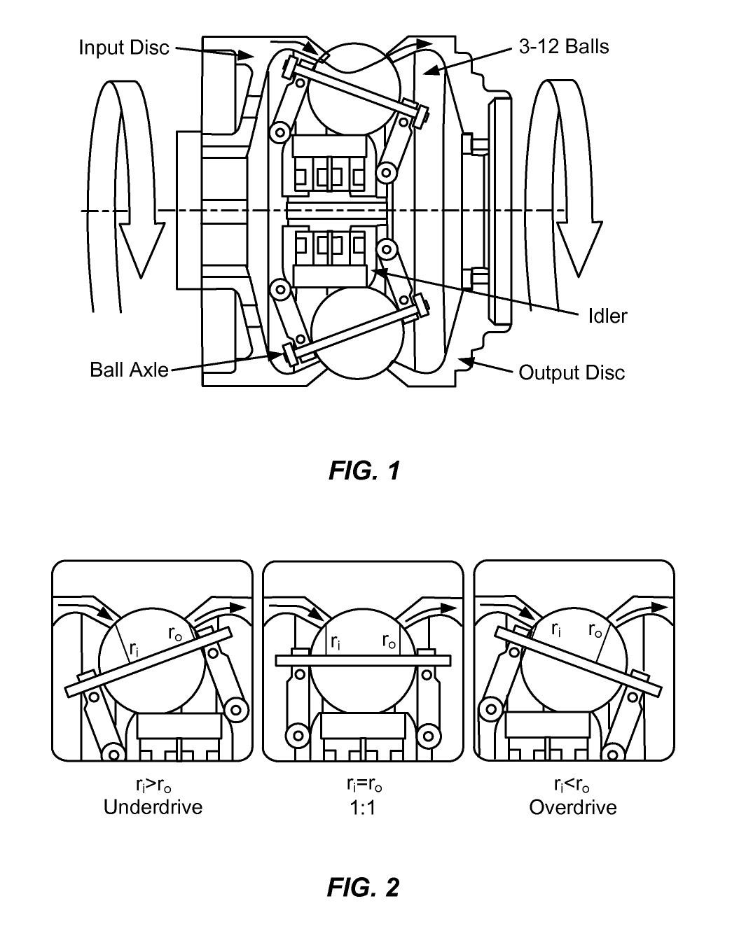

The type of CVT provided herein comprises a variator comprising a plurality of variator balls, depending on the application, two discs or annular rings (input ring, output ring) each having an engagement portion that engages the variator balls. The engagement portions are optionally in a conical or toroidal convex or concave surface contact with the variator balls, as input and output. The variator optionally includes an idler contacting the balls as well as shown on FIG. 1. The variator balls are mounted on axes, themselves held in a cage or carrier allowing changing the ratio by tilting the variator balls' axes. Other types of ball CVTs also exist, like the one produced by Milner, but are slightly different. These alternative ball CVTs are additionally contemplated herein. The working principle generally speaking, of a ball-type variator (i.e. CVP) of a CVT is shown in FIG. 2.

As shown in FIG. 1 or 2, a variator is a system that uses a set of rotating and tilting balls in a carrier that is positioned between an input ring and an output ring. Tilting the balls changes their contact diameters and varies the speed ratio. Contacting a rotating sphere at two different locations relative to the sphere's rotational axis will provide a “gear ratio”, which can range from underdrive to overdrive depending on the location of the contact points for input and output torque and speed. As a result, the variator system offers continuous transition to any ratio within its range, also known as the variator ratio. The gear ratio is shifted by tilting the axes of the spheres in a continuous fashion, to provide different contact radii, which in turn drive the input and output rings, or discs.

The variator, as noted above, has multiple balls to transfer torque through multiple fluid patches. The balls are placed in a circular array around a central idler (sun) and contact separate input and output traction rings engagement portions. This configuration allows the input and output to be concentric and compact. The result is the ability to sweep the transmission through the entire ratio range smoothly, while in motion, under load, or stopped.

The variator itself works with a traction fluid. A traction fluid is optionally located in the variator for lubrication and traction. The lubricant between the ball and the conical rings acts as a solid at high pressure. When this fluid undergoes high contact pressures under rolling contact between the two very hard elements, the balls and the rings, the fluid undergoes a near-instantaneous phase transition to an elastic solid. This is also known as elastohydrodynamic lubrication (EHL). Within this patch of traction the molecules of the fluid stack up and link to form a solid, through which shear force and thus torque can be transferred. Note that the rolling elements are actually not in physical contact when the elements are rotating. The power is thus transferred from the first ring assembly (input of the variator), through the variator balls, to the second ring assembly (output of the variator). By tilting the variator balls' axes, the ratio is changed between input and output. When the axis of each of the variator balls is horizontal the ratio is one, when the axis is tilted the distance between the axis and the contact point change, modifying the overall ratio, between underdrive and overdrive. All the variator balls' axles are tilted at the same time and same angle with a mechanism included in the cage.

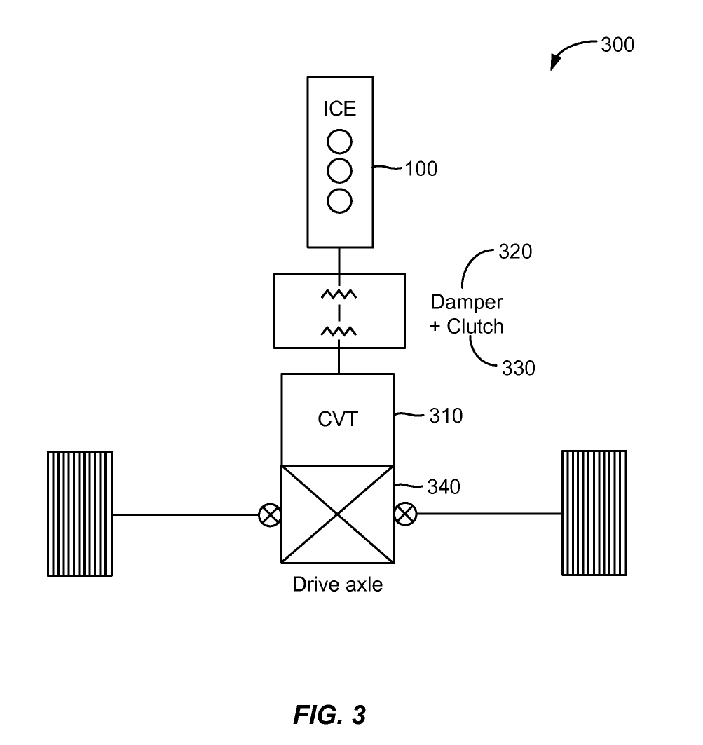

As in a basic driveline configuration 300, the CVT (variator) 310 is used to replace the traditional transmission and is located between the engine 100 (ICE or internal combustion engine) and the differential 340 as shown in FIG. 3. In a typical drivetrain for an Off-Highway (OH) vehicle, a torsional damper 320 (alternatively called a damper) may be introduced between the engine 100 and the CVT 310 to avoid transferring torque peaks and vibrations that could seriously damage the variator 310. In some configurations this damper 320 can be coupled with a clutch 330 for the starting function or to allow the engine to be decoupled from the transmission. Other types of CVT's (apart from ball-type traction drives) can also be used as the variator.

In addition to the configurations described, where the variator is used directly as the primary transmission, other architectures are possible. Various powerpath layouts can be introduced by adding a number of gears, clutches and simple or compound planetary gear sets. In such configurations, the overall transmission can provide several operating modes; a CVT, an IVT, a combined mode and so on.

Introduced within this specification is a configuration based on a similar working principle of using a planetary connected to the ICE and the CVP to allow powersplitting. It has direct drive modes as well as power recirculation modes allowing zero and low speed. Alternate examples of architecture are proposed, but the invention is not restricted to these examples and it is assumed that all layouts that perform similarly to the speed diagram and generic layouts are part of the invention as well.

The embodiments of the present invention as described herein will find many applications. For example, although reference is made to OH vehicular applications, the multi-mode transmission configuration as described herein can be used in many applications where wide speed ranges and/or high rimpull force requirements exist, such as for example, compact wheel loader applications, where an operator may also desire limited jerking motion during shifts in the low speed range. However, small ratio changes may make this transmission suitable for other applications as well, such as off-road leisure vehicles (Jeeps®, or other cross-over vehicles), military vehicles, and other heavy duty applications.

The configuration described herein is based on multi-mode operation. It is one objective to provide smooth and unnoticeable shifts between a certain reverse speed and a certain forward speed, between two different forward speeds or between two different reverse speeds. Outside this area, non-synchronous shift may occur. The various modes are a combination of direct drive or power recirculation. An IVP mode is present, allowing powered neutral feature. In all the modes, the CVP device is speeded-up with a single gear ratio, with the objective of reducing CVP size by running it at high rpms.

This configuration is based on a four mode solution, each mode being selected by closing a clutch/brake and releasing the others. A “common sun” compound planetary is the central part of the configuration together with the CVP.

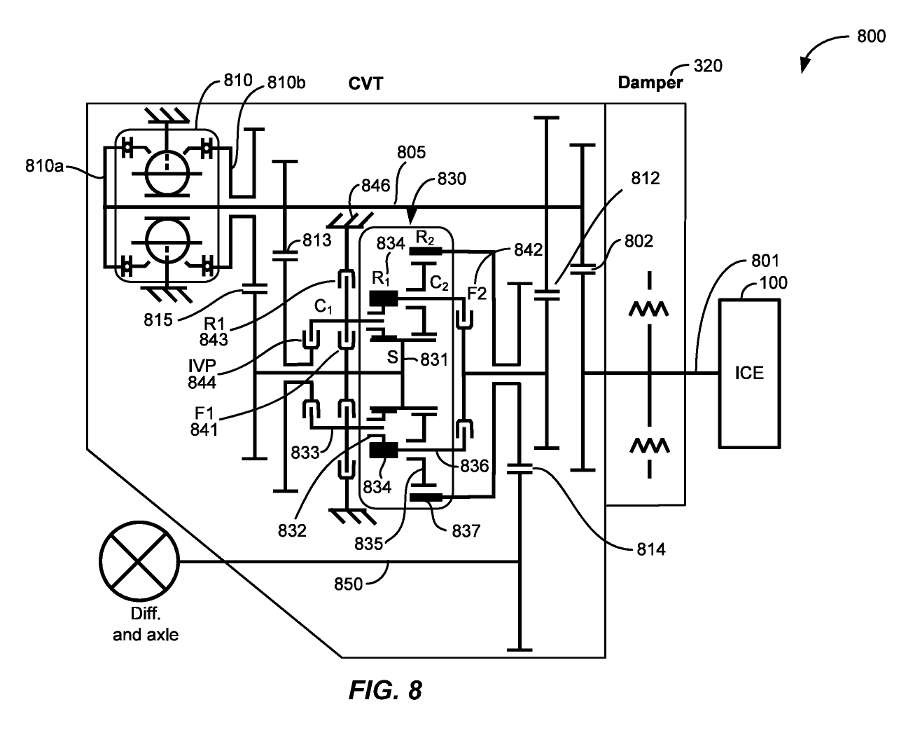

FIG. 8 shows an illustrative example of a physical layout for this configuration. The view is taken from the side of the vehicle. The input (ICE) is always linked to the first ratio going to the CVP, (typically an up-speed ratio). The CVP output is linked to the common sun of the compound planetary by an optional gear ratio. In some iterations, the CVP and the common sun can be on the same shaft, which would eliminate the need for a(n) (up-speed) ratio. The countershaft can be coupled to the second carrier/first ring of the planetary by engaging the clutch F2. In doing so, a second forward mode explained below is selected. The countershaft can also be coupled to the first carrier by engaging the clutch IVP (selecting the IVP mode). In both F2 and IVP modes, the ratios between the ICE and the compound planetary are the product of two gear ratios; the first one between the input and the countershaft and the second one between the countershaft on which is the CVP located and the corresponding planetary element. In this illustrative example, clutch F1 has been drawn between the sun and the first carrier, to lock the planetary in a 1:1 ratio; however, this clutch may be located anywhere else in the planetary, locking two of the rotating elements together to engage the first forward mode F1. Finally, a clutch R1 is providing the reverse mode by braking the first carrier of the planetary.

Provided herein is a variable transmission 800, as illustrated in FIG. 8, based on a four-mode solution comprising: an input shaft 801 drivingly connected to a power source 100 such as an internal combustion engine (ICE); a first (GR1) gear ratio 802; a countershaft 805; a variator (CVP) 810 comprising an input ring assembly 810a drivingly engaged to the countershaft, and an output ring assembly 810b; a compound planetary gearset 830 comprising a plurality of elements, the elements comprising; a common sun gear (S) 831, a first set of planet gears 832, a first carrier (C1) 833, a first ring gear (R1) 834, a second set of planet gears 835, a second carrier (C2) 836 and a second ring gear (R2) 837; a first (F1) clutch 841; a second (F2) clutch 842; a second (GR2) gear ratio 812; a third (R1) clutch 843; a fourth (IVP) clutch 844; a third (GR3) gear ratio 813; a fourth (GR4) gear ratio (SR_AR) 814; and an output shaft 850; wherein the countershaft 805 is linked to the input shaft 801 through the first gear ratio 802 and the variator output ring assembly 810b is linked to the common sun gear 831; and wherein the compound planetary gearset 830 outputs to the second ring gear 837, and wherein the second ring gear is drivingly engaged to the output shaft 850 through the fourth gear ratio (SR_AR) 814.

In preferred embodiments of the variable transmission 800, the first gear ratio 802 is an up-speed ratio. In some embodiments of the variable transmission 800, the first gear ratio 802 is a 1:1 ratio. In some embodiments of the variable transmission 800, the first gear ratio 802 may be a down-speed ratio. In some embodiments of the variable transmission 800, the first gear ratio (802) is not present, wherein the ICE 100 and the variator 810 are on the same shaft.

In preferred embodiments, the variable transmission 800 comprises a 1:1 gear ratio 815 between the variator output ring assembly 810b and the common sun gear 831. In some embodiments of the variable transmission 800, the variator 810 and the common sun 831 are on the same shaft. In some embodiments, the variable transmission 800 further comprises an optional fifth (GR5) gear ratio 815 between the variator output ring assembly 810b and the common sun gear 831 wherein the gear ratio may be an up-speed or a down-speed ratio.

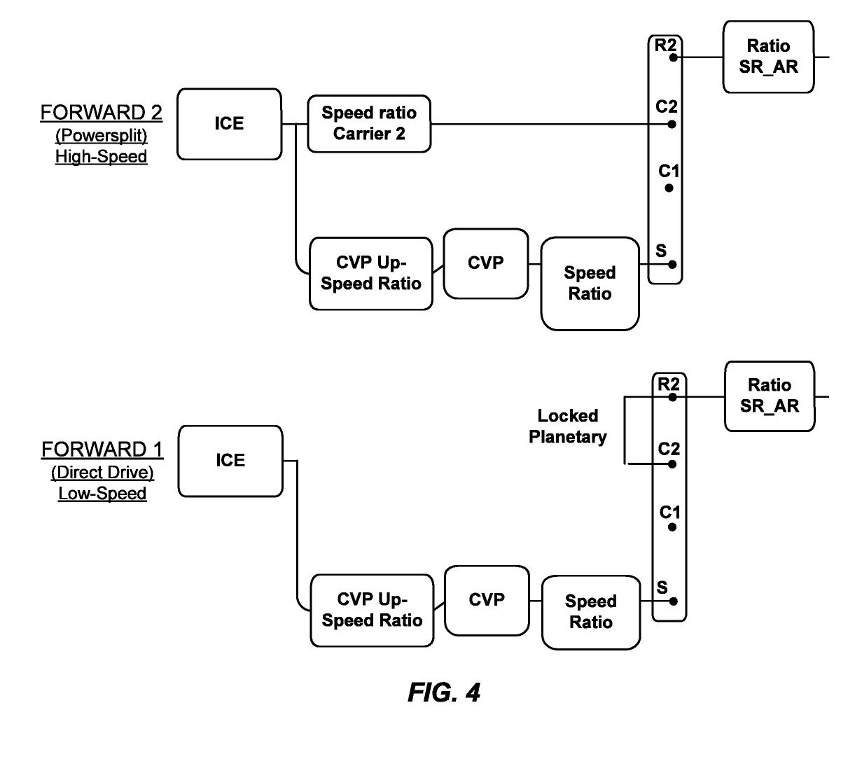

The configuration incorporates two forward modes as shown on FIG. 4. The “Forward 2” mode is a powersplit mode providing the high speed of the vehicle. The CVP is connected to the sun 831 of a compound planetary 830 through one ratio on each side, while the engine 100 is connected to the second carrier 836 of the compound planetary through the first gear ratio (GR1) 802 and the second gear ratio (GR2) 812. The output is made on the second ring 837 of the compound planetary.

The “Forward 1” mode is a direct drive mode in which the compound planetary is locked in a 1:1 ratio; all the power is passing directly through the CVP 810 and going to the output through the second ring 837 of the compound planetary 830. The elements locked together in the compound planetary can be arbitrarily chosen.

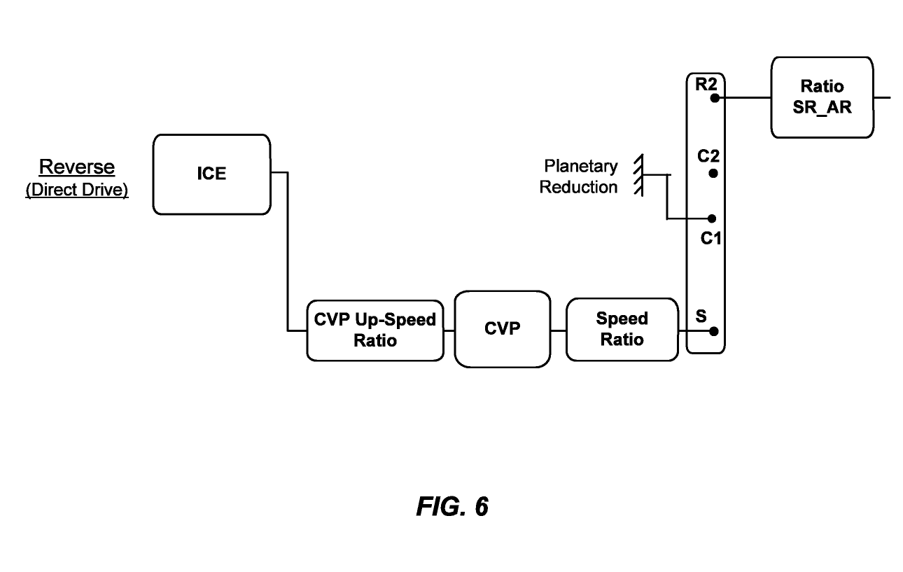

The Reverse mode, shown on FIG. 6 is also a direct drive mode, in the sense that all the power goes through the CVP 810 and the compound planetary 830 is only used as a reduction ratio by locking it to the ground (i.e. grounding) one of the elements; typically the first carrier 833.

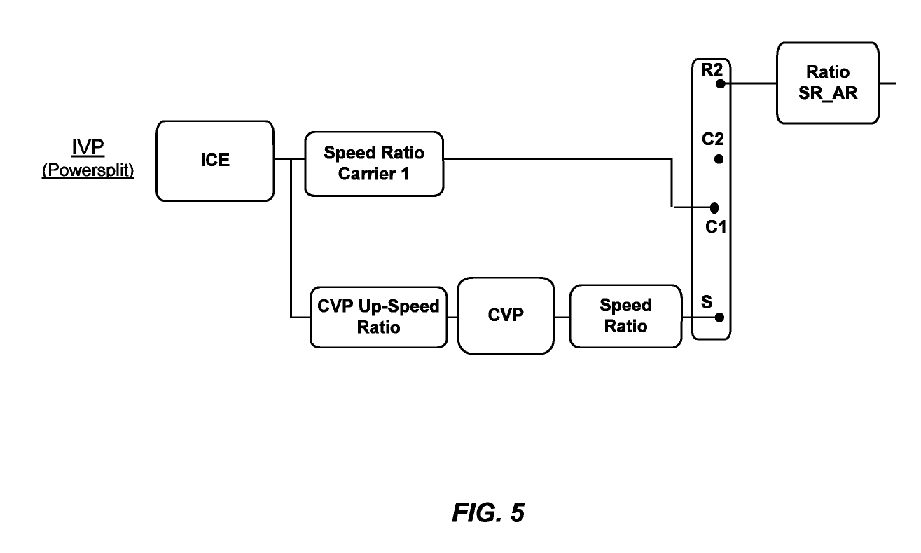

Between these forward and reverse modes, there exists an IVP mode that allows powered neutral feature. This IVP mode, shown on FIG. 5, is a powersplit mode in which the CVP 810 is still connected to the sun 831, but the engine 100 is connected to the first carrier (C1) 833 of the compound planetary by the first gear ratio (GR1) 802 and the third gear ratio (GR3) 813. This mode allows low positive and reverse speeds as well as a powered neutral mode.

The central part of that configuration is the variator 810 described previously. A ball ramp on each side of the variator provides the clamping force necessary to transfer the torque. Due to the compound planetary 830, the configuration is able to provide standstill and reverse function as an IVP by just using a simple CVP variator. No starting device like a slipping clutch or torque converter is required, since the IVP capability takes care of the starting function. However, these devices can be added to allow a safety disconnect or to start the engine. The Ratio after the planetary (Ratio SR_AR) 814 is required to ensure that the maximum speed and torque requirements of the vehicle are still achieved. The output of the transmission is made on the upper (i.e. Ring 2-R2) element 837 of the planetary. The second ring R2 837 is always used as the output of the planetary 830 and goes to the output shaft 850 to drive the vehicle. The CVP is always connected to the ICE through a gear ratio on one side and to the common sun of the planetary on the other side. Other configurations are possible.

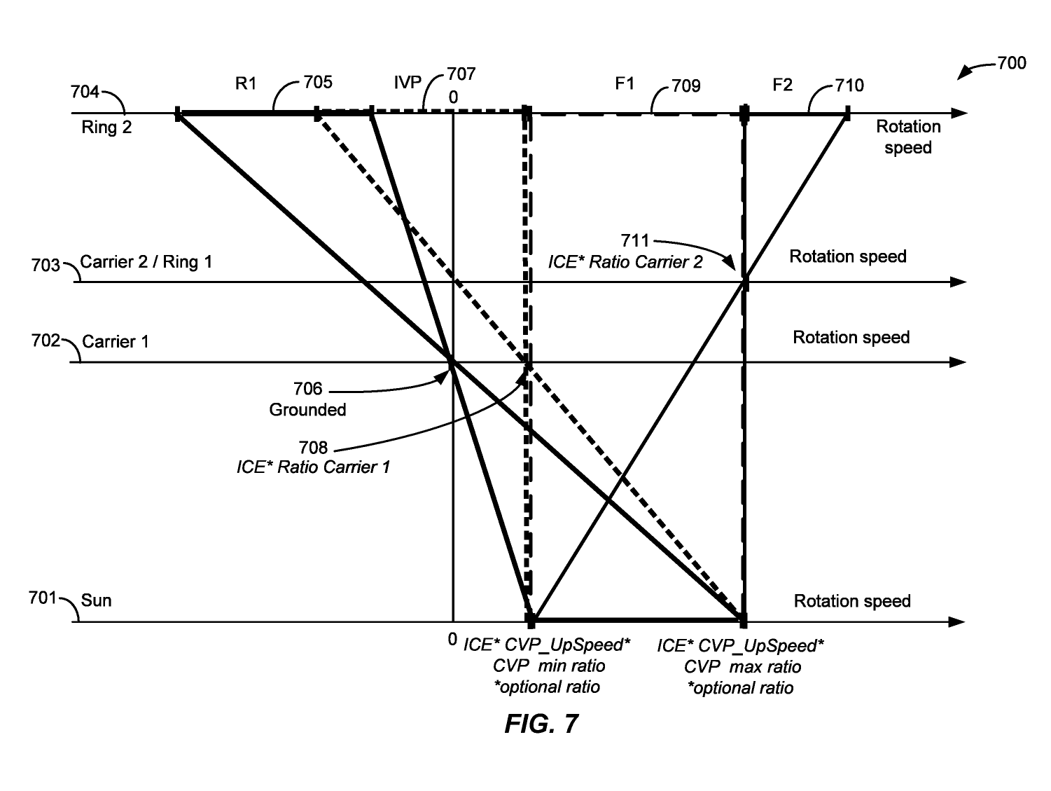

FIG. 7 shows the speed diagram 700 of the compound planetary gearset used within this configuration. The four horizontal axes represent respectively, from the bottom to the top, the sun rotation speed 701, the first carrier rotation speed 702, the second carrier/first ring rotation speed 703 and the second ring rotation speed 704.

In the reverse mode, the clutch connecting the first carrier to the ground 706 is engaged. The planetary is then only used as a single gear ratio. All the other clutches are kept open. The maximum speed ratio of the CVP provides maximum reverse speed while minimum speed ratio of the CVP provides the minimum reverse speed of this mode. The interval 705 shows the speeds achievable in this mode.

The IVP mode is activated by releasing all other clutches and engaging the clutch connecting the first carrier to its corresponding ratio 708. Doing so, the output covers a speed varying from a reverse speed, when CVP is set at its maximum ratio to a forward speed, when the CVP is at its minimum ratio. This is a powersplit mode. The interval 707 shows the speeds achievable in this mode.

The first forward mode is shown in interval 709 on the speed diagram. Two of the planetary elements are locked together so that it gives a 1:1 ratio. Doing so, the output speed of the CVP is same as the output on the second ring. The interval 709 on the Ring2 axis 704 shows the speeds achievable in this mode.

The second forward mode is a powersplit mode in which the second carrier/first ring is connected through a clutch to its corresponding ratio 711. The interval 710 shows the speeds achievable in this mode. A minimum ratio of the CVP corresponds to the maximum speed of this mode while a maximum ratio of the CVP corresponds to the minimum output speed of this mode.

In normal operation of the transmission, only one clutch is closed at a time. However, during transitions between two modes several clutches can be partially closed (e.g. slipping). This is also possible while braking in order to dissipate energy in the transmission.

In some embodiments of the variable transmission 800, the countershaft 805 is coupled to the second carrier 836 and first ring 834 of the compound planetary gearset 830 through the second gear ratio by engaging the second (F2) clutch 842, thus engaging a second forward mode.

In some embodiments of the variable transmission 800, the countershaft 805 is coupled to the first carrier 833 of the compound planetary gearset through the third (GR3) gear ratio 813 by engaging the fourth (IVP) clutch 844, thus engaging an infinitely variable planetary (IVP) mode.

In some embodiments of the variable transmission 800, the first (F1) clutch 841 is configured to lock any two elements of the compound planetary gearset 830 to lock the compound planetary gearset in a 1:1 ratio and thus engaging a first forward mode. In any one of the embodiments of the variable transmission 800, any two elements of the compound planetary gearset 830 are arbitrarily chosen.

In some embodiments of the variable transmission 800, the first (F1) clutch 841 is located anywhere in the compound planetary gearset 830.

In other embodiments of the variable transmission, the first (F1) clutch 841 is located between the sun gear 831 and the first carrier 833 of the compound planetary gearset 830.

In some embodiments of the variable transmission 800, the third (R1) clutch 843 is coupled between the first carrier 833 of the compound planetary gearset 830 and ground 846, and is closed to engage a reverse mode.

The two powersplit modes are modes in which some of the power will flow through the CVP, while the rest will flow directly through a mechanical path. Depending on the selected mode and CVP ratio, the power passing through the variator may be bigger, equal or smaller than the ICE power.

The shifts between the two forward modes and the IVP are synchronous. The shift between the reverse and IVP mode is non-synchronous and additionally, some overlap between the two modes is provided, providing a greater margin in operating and selecting the modes. Overlap can be designed between the other modes by slightly adapting the gear ratios or the planetary, but they would lose their synchronous characteristic.

In some embodiments of the variable transmission, the second forward mode is a powersplit Over-Drive (OD) mode wherein power from the power source is split between the CVP 810 and compound planetary gearset 830. In some embodiments, the second forward mode is configured to deliver high positive speeds, wherein the second forward mode is configured to deliver speeds that are 1) higher than the speeds of first forward mode or 2) overlapping and higher than the speeds of first forward mode.

In some embodiments of the variable transmission, the IVP mode is a powersplit mode wherein power from the power source (ICE) is split between the CVP and the compound planetary gearset. In some embodiments, the IVP mode is configured to deliver low positive and low reverse speeds, wherein the infinitely variable planetary mode is configured to deliver low forward speeds, less than or equal to the first forward mode speeds, and low reverse speeds that overlap one or more low reverse speeds of the reverse mode speeds.

In some embodiments of the variable transmission, the IVP mode is a powersplit mode wherein power from the power source (ICE) is split between the CVP and the compound planetary gearset and the transmission is configured to deliver a powered neutral mode.

In some embodiments of the variable transmission, the first forward mode is a direct-drive mode wherein all power from the power source (ICE) goes through the CVP. In some embodiments, the first forward mode is configured to deliver mid-speeds that are 1) less than all low speeds of the second forward mode or 2) less than and overlapping with the low speeds of the second forward mode and the mid-speeds are a) greater than all high speeds of the infinitely variable planetary mode or b) overlapping and greater than the high speeds of the infinitely variable planetary mode.

In some embodiments of the variable transmission, the reverse mode is a direct drive mode wherein all power from the power source goes through the CVP.

In some embodiments of the variable transmission, shifting between any of the first forward mode, the second forward mode and the infinitely variable planetary (IVP) mode is synchronous. In some embodiments, shifting between the reverse mode and the IVP mode is non-synchronous.

In some embodiments of the variable transmission, a sixth ratio between the power source (ICE) and the compound planetary gearset is the product of the first gear ratio 802 and the second gear ratio 812.

In some embodiments of the variable transmission, a seventh ratio between the power source (ICE) and the compound planetary gearset is the product of the first gear ratio, the variator ratio and a 1:1 ratio between the variator and the common sun. In other embodiments, an eighth ratio between the power source (ICE) and the compound planetary gearset is the product of the first gear ratio, the variator ratio and the optional fifth gear ratio.

In some embodiments of the variable transmission, during normal operation within one mode, comprising a first forward mode, a second forward mode, a reverse mode, or an infinitely variable planetary (IVP), only one clutch is active or closed at one time. In other embodiments, during transitions between two modes, comprising a first forward mode, a second forward mode, a reverse mode, or an infinitely variable planetary (IVP), more than one clutch is partially closed at one time.

In any one of the embodiments of the variable transmission, the output shaft is connected to a differential and axle of a vehicle through the fourth gear ratio (SR_AR).

The present configuration is not restricted to the particular embodiment shown and it is assumed that all the layouts that perform similarly to the speed diagram and generic layouts are part of the invention as well.

This configuration and its layout described, provide a powered neutral ratio. The achieved spread is sufficient to allow the engine to operate at more optimal points, providing fuel economy, while keeping the same operating speeds

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A variable transmission based on a four-mode solution comprising:
an input shaft drivingly connected to a power source;
a first gear ratio;
a countershaft;
a variator comprising an input ring assembly drivingly engaged to the countershaft, and further comprising an output ring assembly;
a compound planetary gearset comprising a plurality of elements, the elements comprising;
a common sun gear,
a first set of planet gears,
a first carrier,
a first ring gear,
a second set of planet gears,
a second carrier, and
a second ring gear;
a first clutch;
a second clutch;
a second gear ratio;
a third clutch;
a fourth clutch;
a third gear ratio;
a fourth gear ratio; and
an output shaft;
wherein the countershaft is linked to the input shaft through the first gear ratio, wherein the output ring assembly is linked to the common sun gear, wherein the compound planetary gearset outputs to the second ring gear, and wherein the second ring gear is drivingly engaged to the output shaft through the fourth gear ratio.

2. The variable transmission of claim 1, further comprising;
an optional fifth gear ratio between the variator output ring assembly and the common sun gear.

3. The variable transmission of claim 1, wherein the countershaft is coupled to the second carrier and the first ring gear of the compound planetary gearset through the second gear ratio by engaging the second clutch, engaging a second forward mode.

4. The variable transmission of claim 1, wherein the countershaft is coupled to the first carrier of the compound planetary gearset through the third gear ratio by engaging the fourth clutch, engaging an infinitely variable planetary mode.

5. The variable transmission of claim 1, wherein the first clutch is configured to lock any two elements of the compound planetary gearset to lock the compound planetary gearset in a 1:1 ratio and engaging a first forward mode.

6. The variable transmission of claim 5, wherein the first clutch is located between the common sun gear and the first carrier of the compound planetary gearset.

7. The variable transmission of claim 1, wherein the third clutch is coupled between the first carrier of the compound planetary gearset and ground, and is closed to engage a reverse mode.

8. The variable transmission of claim 3, wherein the second forward mode is a powersplit mode wherein power from the power source is split between the variator and the compound planetary gearset.

9. The variable transmission of claim 3, wherein the second forward mode is configured to deliver speeds that are:
higher than the speeds of a first forward mode of the variable transmission; or
overlapping and higher than the speeds of the first forward mode.

10. The variable transmission of claim 4, wherein the infinitely variable planetary mode is a powersplit mode wherein power from the power source is split between the variator and the compound planetary gearset.

11. The variable transmission of claim 4, wherein the infinitely variable planetary mode is configured to deliver low forward speeds that are less than or equal to the speeds of a first forward mode of the variable transmission; and low reverse speeds that overlap one or more low reverse speeds of a reverse mode.

12. The variable transmission of claim 4, wherein the infinitely variable planetary mode is a powersplit mode wherein power from the power source is split between the variator and the compound planetary gearset and the transmission is configured to deliver a powered neutral mode.

13. The variable transmission of claim 5, wherein the first forward mode is a direct-drive mode wherein all power from the power source goes through the variator.

14. The variable transmission of claim 5, wherein the first forward mode is configured to deliver mid-speeds that are
less than all low speeds of a second forward mode; or
overlapping with and less than the low speeds of the second forward mode; and the mid-speeds are
greater than all high speeds of an infinitely variable planetary mode; or
overlapping with and greater than the high speeds of the infinitely variable planetary mode.

15. The variable transmission of claim 7, wherein the reverse mode is a direct drive mode wherein all power from the power source goes through the variator.

16. The variable transmission of claim 1, wherein shifting between an infinitely variable planetary (IVP) mode and a first forward mode, and shifting between the first forward mode and a second forward mode is synchronous.

17. The variable transmission of claim 1, wherein shifting between a reverse mode and an infinitely variable planetary (IVP) mode is non-synchronous.

18. The variable transmission of claim 3, wherein a sixth ratio between the power source and the compound planetary gearset is the product of the first gear ratio and the second gear ratio.

19. The variable transmission of claim 4, wherein a seventh ratio between the power source and the compound planetary gearset is the product of the first gear ratio and a 1:1 ratio between the variator and the common sun gear.

20. The variable transmission of claim 4, wherein an eighth ratio between the power source and the compound planetary gearset is the product of the first gear ratio, the variator ratio and the optional fifth gear ratio of claim 2.

21. The variable transmission of claim 1, wherein during normal operation within one mode of a first forward mode, a second forward mode, a reverse mode, or an infinitely variable planetary (IVP) mode, only one of the first clutch, the second clutch, the third clutch or the fourth clutch is active or closed at one time.

22. The variable transmission of claim 1, wherein during transitions between two modes of a first forward mode, a second forward mode, a reverse mode, or an infinitely variable planetary (IVP) mode, at least two of the first clutch, the second clutch, the third clutch or the fourth clutch is partially closed at one time.

23. The variable transmission of claim 1, wherein the output shaft is connected to a differential and an axle of a vehicle through the fourth gear ratio.

24. The variable transmission of claim 1, wherein the first gear ratio is an up-speed ratio.
